(19) United States
(12) Patent Application Publication
(10) Pub. No.: US 2023/0187837 A1
(43) Pub. Date: Jun. 15, 2023

(54) ANTENNA MODULE AND CONNECTION STRUCTURE

(71) Applicant: Murata Manufacturing Co., Ltd., Nagaokakyoshi (JP)

(72) Inventors: Shun SAKAIDA, Nagaokakyo-shi (JP); Kaoru SUDO, Nagaokakyo-shi (JP); Kengo ONAKA, Nagaokakyo-shi (JP)

(73) Assignee: Murata Manufacturing Co., Ltd., Nagaokakyoshi (JP)

(21) Appl. No.: 18/107,571

(22) Filed: Feb. 9, 2023

Related U.S. Application Data
(63) Continuation of application No. PCT/JP2021/018984, filed on May 19, 2021.

(30) Foreign Application Priority Data
Aug. 19, 2020 (JP) 2020-138642

(51) Int. Cl. H01Q 13/08; H01Q 1/48; H01P 5/08

(52) U.S. Cl. CPC H01Q 13/08; H01Q 1/48; H01P 5/08

(57) ABSTRACT

An antenna module includes a dielectric layer in a form of a flat plate, a ground electrode, a radiating element, and a wiring cable. The ground electrode is arranged on a lower surface of the dielectric layer. The radiating element is arranged on an upper surface of the dielectric layer as being opposed to the ground electrode. The wiring cable faces a side surface of the dielectric layer, and includes a ground electrode and a power feeder line that conveys a radio frequency signal to the radiating element. The wiring cable is smaller in thickness than the dielectric layer. The power feeder line and the ground electrode are electrically connected to the radiating element and the ground electrode, respectively. The ground electrode is arranged at a position different from a position of the ground electrode in a direction of thickness of the dielectric layer.

### CROSS-REFERENCE TO RELATED APPLICATIONS

The present application claims priority to Japanese patent application 2020-138642, filed in the Japanese Patent Office on Aug. 19, 2020, and International Patent Application PCT/JP2021/018984 filed May 19, 2021, the entire contents of each of which in incorporated herein by reference in its entirety.

### TECHNICAL FIELD

The present disclosure relates to an antenna module and a connection structure that connects an antenna apparatus and a wiring cable to each other included in the antenna module.

### BACKGROUND ART

WO2018/180035 (PTL 1) discloses a construction in a planar antenna in which a flexible dielectric film portion where a power feeder line is formed, seamlessly extends from an antenna base having a dielectric layer disposed between a radiating element and a ground conductor.

### CITATION LIST

### Patent Literature

PTL 1: WO2018/180035

### SUMMARY

### Technical Problems

In the construction in WO2018/180035 (PTL 1), the dielectric film portion with the power feeder line is formed integrally with the antenna base so as to seamlessly extend from the antenna base. In other words, the dielectric film portion is formed in advance in a process for manufacturing the antenna base.

On the other hand, an antenna module may be formed by connecting an individually manufactured wiring cable to an antenna apparatus where a radiating element is arranged. In this case, the wiring cable is generally connected on a main surface side of the antenna apparatus with the use of a connector or solder. In this case, since the entire device including the wiring cable has a large thickness, the thickness of the antenna apparatus may be restricted by a dimension of the device as prescribed by a specification.

Restriction of the thickness of the antenna apparatus results in restriction of a distance between the radiating element and a ground electrode. Therefore, a frequency bandwidth of radiated radio waves becomes narrower and desired antenna characteristics may not be achieved.

The present disclosure was made to solve the above-identified, and other problems, and an aspect thereof is to provide a connection structure for connection between an antenna apparatus and a wiring cable, in order to achieve suppression of a lowering in antenna characteristics while suppression of increased dimension of a device in a direction of thickness in an antenna module.

### SOLUTIONS TO PROBLEMS

Accordingly, one non-limiting antenna module according to one aspect of the present disclosure includes a dielectric layer in a form of a flat plate, a ground electrode, a radiating element, and a wiring cable. The ground electrode is arranged on a lower surface of the dielectric layer. The radiating element is arranged on an upper surface of the dielectric layer as being opposed to the ground electrode. The wiring cable faces a side surface of the dielectric layer, and includes a ground electrode and a power feeder line that conveys a radio frequency signal to the radiating element. The wiring cable is smaller in thickness than the dielectric layer. The power feeder line and the ground electrode are electrically connected to the radiating element and the ground electrode, respectively. The ground electrode is arranged at a position different from a position of the ground electrode in a direction of thickness of the dielectric layer.

A connection structure according to another aspect of the present disclosure relates to a structure that connects an antenna apparatus and a wiring cable to each other. The antenna apparatus includes a dielectric layer in a form of a flat plate, a first ground electrode arranged on a first surface of the dielectric layer, and a radiating element arranged on a second surface of the dielectric layer and opposed to the first ground electrode. The wiring cable faces a side surface of the dielectric layer. The wiring cable includes a second ground electrode and a power feeder line that conveys a radio frequency signal to the radiating element. The wiring cable is smaller in thickness than the dielectric layer. The power feeder line and the second ground electrode are electrically connected to the radiating element and the first ground electrode, respectively. The second ground electrode is arranged at a position different from a position of the first ground electrode in a direction of thickness of the dielectric layer.

### ADVANTAGEOUS EFFECTS OF DISCLOSURE

According to the antenna module and the connection structure according to the present disclosure, the wiring cable smaller in thickness than the dielectric layer of the antenna apparatus is arranged as facing the side surface of the dielectric layer. The power feeder line of the wiring cable and the radiating element are electrically connected to each other, and the ground electrodes of the wiring cable and the antenna apparatus are electrically connected to each other. The ground electrode of the wiring cable and the ground electrode of the antenna apparatus are arranged at positions different from each other in the direction of thickness of the dielectric layer. According to such a construction, connection to the wiring cable at a main surface of the antenna apparatus is avoided and the thickness of the dielectric layer is not restricted by the wiring cable. Therefore, increase in dimension of a device in the direction of thickness can be suppressed while lowering in antenna characteristics can be suppressed.

### BRIEF DESCRIPTION OF DRAWINGS

FIG. 1 is a block diagram of a communication apparatus on which an antenna module according to a first embodiment is mounted.

FIG. 2 includes sub-figure FIG. 2(a) as a plan view and sub-FIG. 2(b) as a side perspective view of an antenna apparatus and a wiring cable in FIG. 1.

FIG. 3 is a cross-sectional view along the line in FIG. 2.

FIG. 4 includes sub-FIG. 4(a) as a plan view and sub-FIG. 4(b) as a side perspective view of the antenna apparatus and the wiring cable in the antenna module in a first modification.

FIG. 5 is a cross-sectional view along the line V-V in FIG. 4.

FIG. 6 includes sub-FIG. 6(a) as a plan view and sub-FIG. 6(b) as a side perspective view of the antenna apparatus and a wiring cable in the antenna module in a second modification.

FIG. 7 is a cross-sectional view along the line VII-VII in FIG. 6.

FIG. 8 includes sub-FIG. 8(a) as a plan view and sub-FIG. 8(b) as a side perspective view of the antenna apparatus and a wiring cable in the antenna module in a third modification.

FIG. 9 is a cross-sectional view along the line IX-IX in FIG. 8.

FIG. 10 includes sub-FIG. 10(a) as a plan view and sub-FIG. 10(b) as a side perspective view of the antenna apparatus and a wiring cable in the antenna module in a second embodiment.

FIG. 11 is a cross-sectional view along the line XI-XI in FIG. 10.

FIG. 12 is a plan view of the antenna apparatus and a wiring cable in the antenna module in a fourth modification.

FIG. 13 includes sub-FIG. 13(a) as a plan view and sub-FIG. 13(b) as a side perspective view of an antenna apparatus and a wiring cable in the antenna module in a third embodiment.

FIG. 14 is a cross-sectional view along the line XIV-XIV in FIG. 13.

FIG. 15 is a side perspective view of the antenna apparatus and the wiring cable in the antenna module in a fifth modification.

FIG. 16 is a side perspective view of the antenna apparatus and the wiring cable in the antenna module in a sixth modification.

FIG. 17 is a side perspective view of the antenna apparatus and the wiring cable in the antenna module in a seventh modification.

FIG. 18 is a side perspective view of the antenna apparatus and the wiring cable in the antenna module in an eighth modification.

FIG. 19 is a plan view of an antenna apparatus and the wiring cable in the antenna module in a fourth embodiment.

FIG. 20 is a plan view of an antenna apparatus and a wiring cable in the antenna module in a ninth modification.

### DESCRIPTION OF EMBODIMENTS

An embodiment of the present disclosure will be described in detail below with reference to the drawings. The same or corresponding elements in the drawings have the same reference characters allotted and description thereof will not be repeated.

### First Embodiment

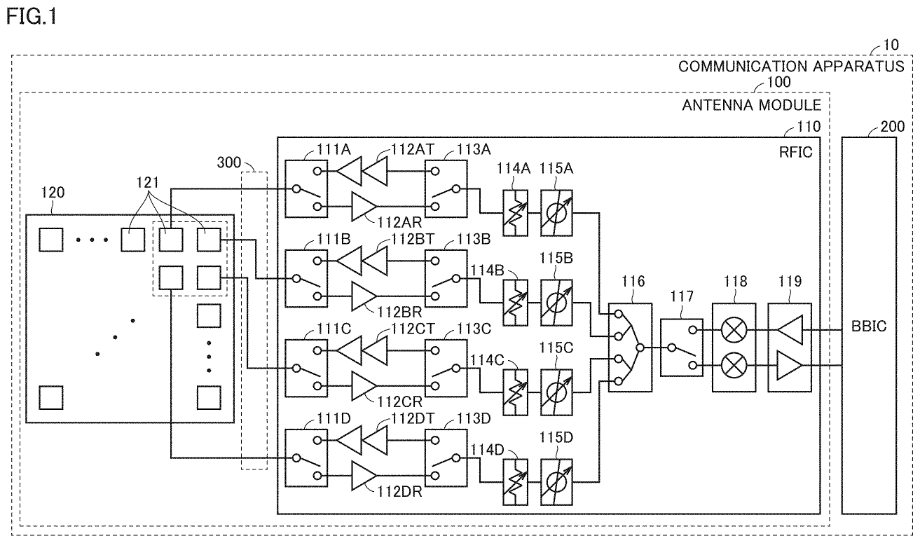

(Basic Configuration of Communication Apparatus) FIG. 1 is an exemplary block diagram of a communication apparatus 10 according to the present embodiment. Communication apparatus 10 is, for example, a mobile terminal such as a portable telephone, a smartphone, or a tablet, a personal computer with a communication function, or a base station. Though exemplary frequency bands of radio waves used in an antenna module 100 according to the present embodiment include radio waves in a millimeter wave band with 28 GHz, 39 GHz, and 60 GHz being defined as central frequencies, radio waves in a frequency band other than the former are also applicable.

Referring to FIG. 1, communication apparatus 10 includes antenna module 100 and a BBIC 200 that implements a baseband signal processing circuit. Antenna module 100 includes a radio frequency (RF) integrated circuit (RFIC) 110 representing an exemplary power feed circuit, and an antenna apparatus 120. Communication apparatus 10 up-converts, in RFIC 110, a signal transmitted from BBIC 200 to antenna module 100 to a high-frequency signal, and radiates the high-frequency signal from antenna apparatus 120 through a wiring cable 300. In this context “high-frequency” refers more generally to RF. Communication apparatus 10 transmits a high-frequency signal received by antenna apparatus 120 to RFIC 110 through wiring cable 300, down-converts the high-frequency signal, and processes the resultant signal in baseband integrated circuitry (BBIC) 200.

FIG. 1 shows only features corresponding to four radiating elements 121 among a plurality of radiating elements 121 included in antenna apparatus 120 for facilitation of description, and does not show features corresponding to other radiating elements 121 similar in configuration. Though FIG. 1 shows an example in which antenna apparatus 120 is formed from a plurality of radiating elements 121 arranged in a two-dimensional array, a plurality of radiating elements 121 do not necessarily have to be provided, and antenna apparatus 120 may be formed from a single radiating element 121. Alternatively, a one-dimensional array may be applicable where a plurality of radiating elements 121 are arranged in a line. Though a patch antenna in a form of a flat plate in a substantially square shape is described by way of example of radiating element 121, radiating element 121 may be in a circular shape, an oval shape, or another polygonal shape such as a hexagonal shape.

RFIC 110 includes switches 111A to 111D, 113A to 113D, and 117, power amplifiers 112AT to 112DT, low noise amplifiers 112AR to 112DR, attenuators 114A to 114D, phase shifters 115A to 115D, a signal synthesizer/separator 116, a mixer 118, and an amplifier circuit 119. The switching is computer or circuitry controlled.

In transmission of a high-frequency signal, switches 111A to 111D and 113A to 113D are switched to a side of power amplifiers 112AT to 112DT, and switch 117 is connected to a transmission-side amplifier of amplifier circuit 119. In reception of a high-frequency signal, switches 111A to 111D and 113A to 113D are switched to a side of low noise amplifiers 112AR to 112DR, and switch 117 is connected to a reception-side amplifier of amplifier circuit 119.

A signal transmitted from BBIC 200 is amplified by amplifier circuit 119 and up-converted by mixer 118. A transmission signal which is the up-converted high-frequency signal is separated into four signals by signal synthesizer/separator 116, and the four signals pass through four respective signal paths and fed to respective different radiating elements 121. At this time, amounts of phase shifts imparted by phase shifters 115A to 115D arranged in the signal paths can individually be adjusted to adjust directivity of antenna apparatus 120. Attenuators 114A to 114D adjust intensity of transmission signals.

Reception signals which are high-frequency signals received at respective radiating elements 121 pass through four respective different signal paths and synthesized by signal synthesizer/separator 116. The synthesized reception signal is down-converted by mixer 118, amplified by amplifier circuit 119, and transmitted to BBIC 200.

RFIC 110 is formed, for example, as a one-chip integrated circuit component with the circuit configuration above. Alternatively, a device (a switch, a power amplifier, a low noise amplifier, an attenuator, and a phase shifter) corresponding to each radiating element 121 in RFIC 110 may be formed as a one-chip integrated circuit component for each corresponding radiating element 121.

(Connection Structure That Connects Antenna Apparatus and Wiring Cable to Each Other)

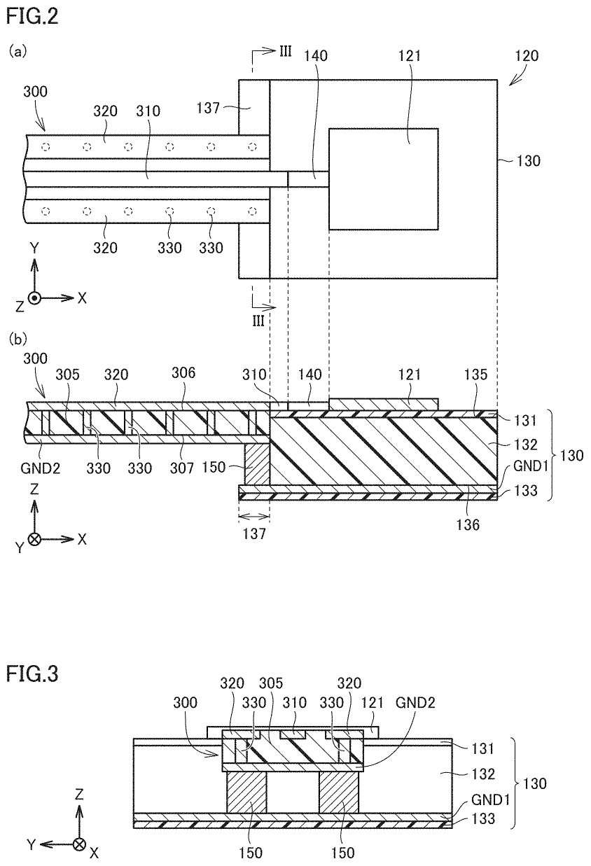

Details of a connection structure that connects antenna apparatus 120 and wiring cable 300 to each other in FIG. 1 will now be described with reference to FIGS. 2 and 3. FIG. 2 is a plan view (FIG. 2 (a)) and a side perspective view (FIG. 2 (b)) of a portion of connection between antenna apparatus 120 and wiring cable 300. FIG. 3 is a cross-sectional view along the line in FIG. 2. FIGS. 2 and 3 illustrate an example in which antenna apparatus 120 includes a single radiating element 121 for facilitation of description.

In the description hereafter, a direction of thickness of antenna apparatus 120 is defined as a Z-axis direction and a plane perpendicular to the Z-axis direction is defined by an X axis and a Y axis. A positive direction of the Z axis in each figure may be referred to as an upper surface side and a negative direction thereof may be referred to as a lower surface side.

Referring to FIGS. 2 and 3, antenna apparatus 120 includes a dielectric substrate 130, radiating element 121, and a wiring portion 140. Dielectric substrate 130 includes dielectric films 131 and 133, a dielectric layer 132, and a ground electrode GND1 (first ground electrode).

Dielectric layer 132 is, for example, a multilayer substrate of low temperature co-fired ceramics (LTCC), a multilayer resin substrate formed by layering a plurality of resin layers composed of such a resin as epoxy or polyimide, a multilayer resin substrate formed by layering a plurality of resin layers composed of a liquid crystal polymer (LCP) lower in dielectric constant, a multilayer resin substrate formed by layering a plurality of resin layers composed of a fluorine-based resin, a multilayer resin substrate formed by layering a plurality of resin layers composed of a polyethylene terephthalate (PET) material, or a multilayer substrate of ceramic other than LTCC. Dielectric substrate 130 may be formed of glass or plastic or may be a single-layer substrate.

Dielectric film 131 is arranged on an upper surface (second surface) 135 of dielectric layer 132, and radiating element 121 is arranged on an upper surface of dielectric film 131. Ground electrode GND1 is arranged on a lower surface (first surface) 136 of dielectric layer 132, as being opposed to radiating element 121. Dielectric film 133 is arranged on a lower surface of ground electrode GND1.

Ground electrode GND1 and dielectric film 133 project from an end surface of dielectric layer 132 in the negative direction of the X axis. A portion that projects is referred to as a “projecting portion 137” (first projecting portion).

Wiring cable 300 includes a dielectric layer 305, a power feeder line 310, a ground wire 320, and a ground electrode GND2 (second ground electrode). Dielectric layer 305 is formed, for example, of a liquid crystal polymer (LCP). Dielectric layer 305 is smaller in thickness (a dimension in the Z-axis direction) than dielectric layer 132 of dielectric substrate 130. According to such a construction, dielectric layer 305 functions as a flexible cable having flexibility.

Ground electrode GND2 is arranged on a lower surface (first surface) 307 of dielectric layer 305. On an upper surface (second surface) 306 of dielectric layer 305, power feeder line 310 and ground wire 320 that extends along each of opposing sides of power feeder line 310 are arranged. Ground wire 320 is connected to ground electrode GND2 through a plurality of columnar electrodes (vias) 330. In other words, in the plan view of FIG. 2(a), power feeder line 310 and ground wire 320 form a coplanar line.

Wiring cable 300 is arranged such that one end of dielectric layer 305 in a direction of extension of power feeder line 310 faces the end surface of dielectric layer 132 of antenna apparatus 120. In wiring cable 300, upper surface 306 of dielectric layer 305 is arranged at a position that coincides with upper surface 135 of dielectric layer 132. An end of power feeder line 310 projects from the end surface of dielectric layer 305 and is connected to wiring portion 140 at the upper surface of dielectric film 131. Power feeder line 310 may directly be connected to wiring portion 140 by compression bonding or capacitively coupled thereto at a short distance therefrom. A portion of power feeder line 310 and wiring portion 140 on dielectric film 131 is longer in distance to the ground electrode than wiring cable 300 and that portion is different in impedance from wiring cable 300. Then, appropriate impedance matching may not be achieved. Therefore, a length of that portion is preferably minimized.

A part of ground electrode GND2 arranged on the lower surface of wiring cable 300 is opposed to ground electrode GND1 in projecting portion 137. In other words, ground electrode GND1 and ground electrode GND2 are arranged at positions different from each other in the direction of thickness of dielectric layer 132. In projecting portion 137, ground electrode GND1 and ground electrode GND2 are electrically connected to each other through solder 150. Though not shown in the figure, wiring cable 300 has the other end connected to RFIC 110 in FIG. 1. A high-frequency signal from RFIC 110 is thus transmitted to radiating element 121 of antenna apparatus 120 through wiring cable 300. “Solder 150” (FIG. 3) in the first embodiment represents an exemplary “connection member” in the present disclosure.

In forming an antenna module by connecting an individual wiring cable to an antenna apparatus, the wiring cable may be connected with the use of a connector or the like on the upper surface or the lower surface of the antenna apparatus. In this case, the entire device including the wiring cable has a large thickness, which may restrict the thickness of the antenna apparatus (dielectric layer) due to a dimension of the device under the specifications.

In an antenna apparatus including a patch antenna in a form of a flat plate, generally, a frequency bandwidth of radiated radio waves can be broadened by increasing a distance between the radiating element and the ground electrode, that is, by increasing the thickness of the dielectric layer. When the thickness of the dielectric layer is restricted by a manner of connection between the antenna apparatus and the wiring cable as above, however, a desired frequency bandwidth may not be secured.

In the antenna module according to the present first embodiment, ground electrode GND2 of wiring cable 300 and ground electrode GND1 of antenna apparatus 120 are independent of each other as described above, and they are arranged as facing the side surface of dielectric layer 132 at positions different in the direction of thickness of dielectric layer 132. Therefore, connection to wiring cable 300 at upper surface 135 and lower surface 136 of dielectric layer 132 can be avoided, and the thickness of dielectric layer 132 of antenna apparatus 120 can be set without being affected by the thickness of dielectric layer 305 of wiring cable 300. Therefore, the bandwidth can be broader by increasing the thickness of dielectric layer 132 of antenna apparatus 120, and increase in dimension of the device in the direction of thickness can be suppressed. Since dielectric layer 305 of wiring cable 300 is smaller in thickness than dielectric layer 132 of antenna apparatus 120, flexibility of wiring cable 300 can be secured.

(First Modification)

An example in which ground electrode GND2 of wiring cable 300 and ground electrode GND1 of antenna apparatus 120 are connected to each other through solder is described for the antenna module in the first embodiment. In a first modification, an exemplary construction in which wiring cable 300 and ground electrode GND1 are connected to each other through an anisotropic conductive film will be described.

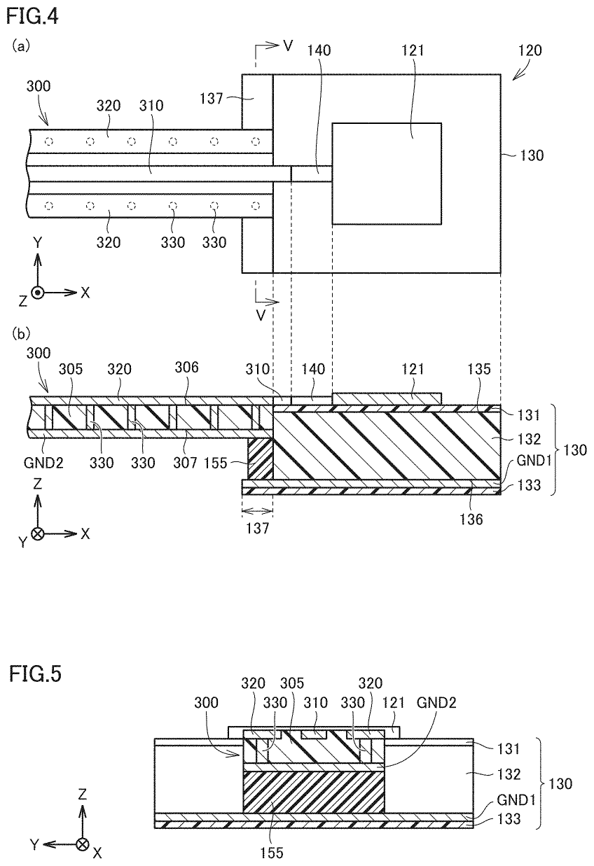

FIGS. 4 and 5 are diagrams for illustrating details of a connection structure in the first modification, that connects antenna apparatus 120 and wiring cable 300 to each other. FIG. 4 is a plan view (FIG. 4 (a)) and a side perspective view (FIG. 4 (b)) of a portion of connection between antenna apparatus 120 and wiring cable 300. FIG. 5 is a cross-sectional view along the line V-V in FIG. 4.

In FIGS. 4 and 5, solder 150 in FIGS. 2 and 3 described in the first embodiment is replaced with an anisotropic conductive film 155, and the construction is otherwise similar. Description of elements in FIGS. 4 and 5 similar to those in FIGS. 2 and 3 in the first embodiment will not be repeated.

Referring to FIGS. 4 and 5, in projecting portion 137 in dielectric substrate 130, anisotropic conductive film (ACF) 155 is arranged between ground electrode GND1 and ground electrode GND2. Anisotropic conductive film 155 is a member obtained by forming into a film, a mixture of fine metal particles into a thermosetting resin such as acrylic or epoxy. In anisotropic conductive film 155, as a result of partial pressurization while it is heated with a heater, a conductive path is provided in the pressurized portion whereas insulation is maintained in a portion not pressurized.

In an actual antenna module, an interval between ground electrode GND2 of wiring cable 300 and ground electrode GND1 of antenna apparatus 120 is approximately not larger than 20 μm, and hence connection through solder may be difficult. In such a case, wiring cable 300 can be arranged in projecting portion 137 with anisotropic conductive film 155 being interposed, and heating and compression bonding can be carried out to thereby readily provide a conductive path between ground electrodes.

“Anisotropic conductive film 155” in the first modification represents an exemplary “connection member” in the present disclosure. Instead of anisotropic conductive film 155, a conductive material like a paste may be employed.

In an example where the anisotropic conductive film is employed for connection between the ground electrode of the wiring cable and the ground electrode of the antenna apparatus as in the first modification as well, the antenna apparatus and the wiring cable are arranged as described in the first embodiment. Therefore, the frequency bandwidth can be broader and increase in dimension of the device in the direction of thickness can be suppressed.

(Second Modification)

An example in which the coplanar line is formed on upper surface 306 of dielectric layer 305 in wiring cable 300 is described in the first embodiment. In a second modification, an exemplary construction in which a coplanar line is formed on lower surface 307 of dielectric layer 305 will be described.

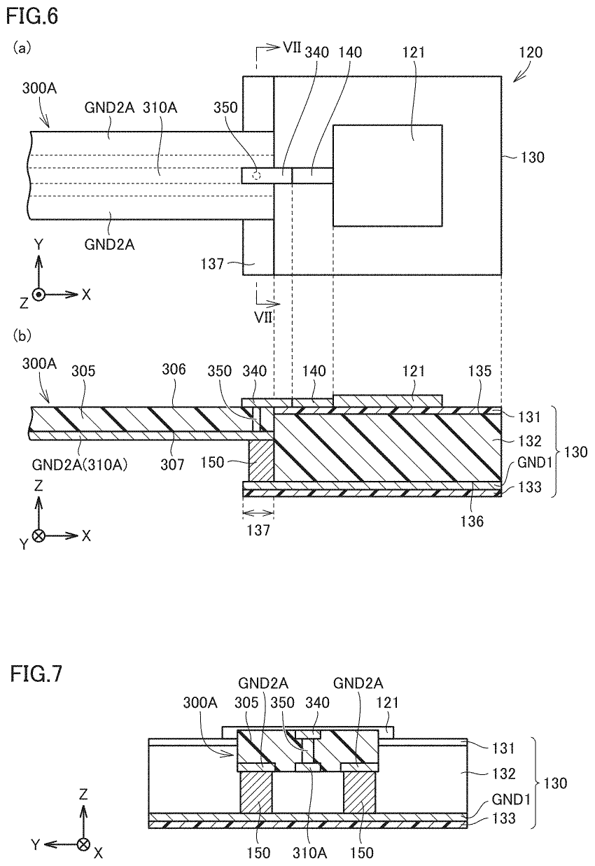

FIGS. 6 and 7 are diagrams for illustrating details of a connection structure in the second modification, that connects antenna apparatus 120 and a wiring cable 300A to each other. FIG. 6 is a plan view (FIG. 6 (a)) and a side perspective view (FIG. 6 (b)) of a portion of connection between antenna apparatus 120 and wiring cable 300A. FIG. 7 is a cross-sectional view along the line VII-VII in FIG. 6.

In FIGS. 6 and 7, wiring cable 300 in FIGS. 2 and 3 described in the first embodiment is replaced with wiring cable 300A, and the construction is otherwise similar. Description of elements in FIGS. 6 and 7 similar to those in FIGS. 2 and 3 will not be repeated.

Referring to FIGS. 6 and 7, in wiring cable 300A, a power feeder line 310A is arranged on lower surface 307 of dielectric layer 305, and a ground electrode GND2A is arranged along each of opposing sides of power feeder line 310A. Power feeder line 310A and ground electrode GND2A form a coplanar line.

A wiring portion 340 is formed in a region close to an end on a side of antenna apparatus 120, of upper surface 306 of dielectric layer 305 in wiring cable 300A. Wiring portion 340 and power feeder line 310A on lower surface 307 are connected to each other through a via 350. Wiring portion 340 is connected to wiring portion 140 at the upper surface of dielectric film 131 in antenna apparatus 120.

Ground electrode GND2A is connected to ground electrode GND1 through solder 150 in projecting portion 137. According to such a construction, a high-frequency signal from RFIC 110 is transmitted to radiating element 121 through wiring cable 300A.

In an example where wiring cable 300A as in the second modification is employed as well, the antenna apparatus and the wiring cable are arranged as described in the first embodiment. Therefore, the frequency bandwidth can be broader and increase in dimension of the device in the direction of thickness can be suppressed.

(Third Modification)

An exemplary construction in which a wiring cable is formed from a microstrip line will be described in a third modification.

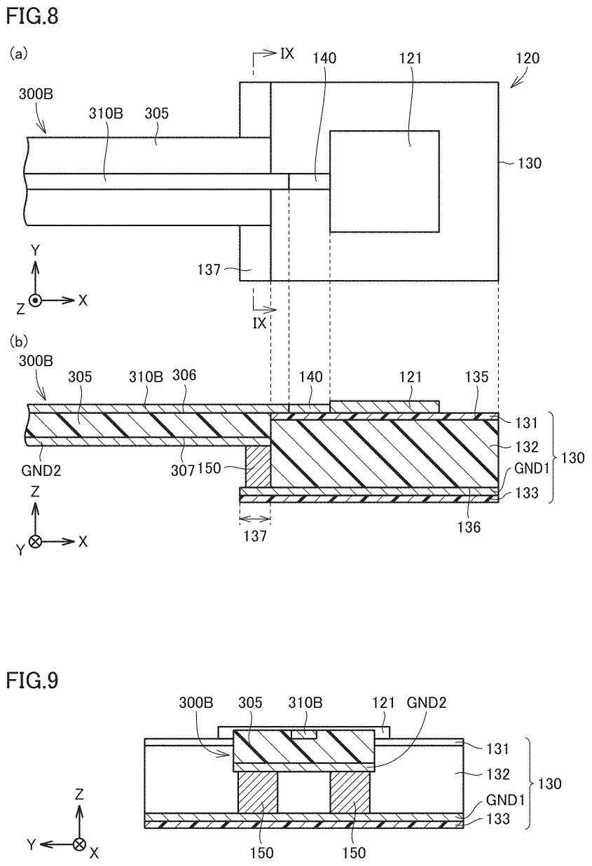

FIGS. 8 and 9 are diagrams for illustrating details of a connection structure in the third modification, that connects antenna apparatus 120 and a wiring cable 300B to each other. FIG. 8 is a plan view (FIG. 8 (a)) and a side perspective view (FIG. 8 (b)) of a portion of connection between antenna apparatus 120 and wiring cable 300B. FIG. 9 is a cross-sectional view along the line IX-IX in FIG. 8.

In FIGS. 8 and 9, wiring cable 300 in FIGS. 2 and 3 described in the first embodiment is replaced with wiring cable 300B, and the construction is otherwise similar. Description of elements in FIGS. 8 and 9 similar to those in FIGS. 2 and 3 will not be repeated.

Referring to FIGS. 8 and 9, in wiring cable 300B, a power feeder line 310B is arranged on upper surface 306 of dielectric layer 305, and ground electrode GND2 is arranged on lower surface 307 of dielectric layer 305. Power feeder line 310B and ground electrode GND2 form a microstrip line.

Power feeder line 310B has a part projecting from an end of dielectric layer 305 on the side of antenna apparatus 120 similarly to power feeder line 310 in the first embodiment. Power feeder line 310B is connected to wiring portion 140 at the upper surface of dielectric film 131 of antenna apparatus 120.

Ground electrode GND2 is connected to ground electrode GND1 through solder 150 in projecting portion 137. According to such a construction, a high-frequency signal from RFIC 110 is transmitted to radiating element 121 through wiring cable 300B.

In an example where wiring cable 300B as described in the third modification is employed as well, the antenna apparatus and the wiring cable are arranged as in the first embodiment. Therefore, the frequency bandwidth can be broader and increase in dimension of the device in the direction of thickness can be suppressed.

Though not shown in the figure, the wiring cable may be formed as a strip line.

### Second Embodiment

A construction in which the ground electrode of the wiring cable and the ground electrode of the antenna apparatus are directly connected to each other is described in the first embodiment and the first to third modifications. In a second embodiment, a construction in which the ground electrode of the wiring cable and the ground electrode of the antenna apparatus are capacitively coupled to each other will be described.

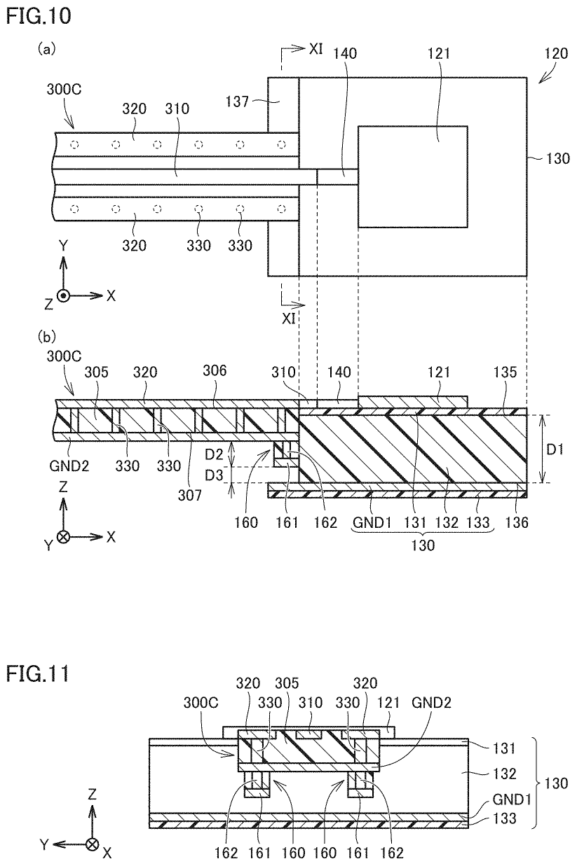

FIGS. 10 and 11 are diagrams for illustrating details of a connection structure in the second embodiment, that connects antenna apparatus 120 and a wiring cable 300C to each other. FIG. 10 is a plan view (FIG. 10 (a)) and a side perspective view (FIG. 10 (b)) of a portion of connection between antenna apparatus 120 and wiring cable 300C. FIG. 11 is a cross-sectional view along the line XI-XI in FIG. 10.

In FIGS. 10 and 11, wiring cable 300 in FIGS. 2 and 3 described in the first embodiment is replaced with wiring cable 300C, and the construction is otherwise similar. Description of elements in FIGS. 10 and 11 similar to those in FIGS. 2 and 3 will not be repeated.

Referring to FIGS. 10 and 11, wiring cable 300C is constructed such that a protrusion 160 that protrudes from the lower surface is formed in a region opposed to projecting portion 137 of antenna apparatus 120 on a lower surface side of wiring cable 300 in the first embodiment. Protrusion 160 includes a flat electrode 161 and a columnar electrode 162. Flat electrode 161 is arranged between ground electrode GND1 and ground electrode GND2. Columnar electrode 162 connects flat electrode 161 and ground electrode GND2 to each other. A dielectric may be arranged between flat electrode 161 and ground electrode GND2. Though a space may be provided between flat electrode 161 and ground electrode GND1, the space may be filled with a resin relatively low in dielectric constant.

Though FIG. 11 shows an exemplary construction in which two protrusions 160 are formed, a single protrusion 160 or at least three protrusions 160 may be provided. Protrusion 160 may be formed as far as an end of ground electrode GND2 in the Y-axis direction in wiring cable 300C. Alternatively, a protrusion may be formed on a side of ground electrode GND1.

“Protrusion 160” in the second embodiment corresponds to the “first protrusion” in the present disclosure. “Flat electrode 161” in the second embodiment corresponds to the “first electrode” in the present disclosure.

According to such a construction, flat electrode 161 and ground electrode GND1 are capacitively coupled to each other. At this time, by changing a thickness D2 of protrusion 160 to adjust a distance D3 between flat electrode 161 and ground electrode GND1, strength of capacitive coupling between flat electrode 161 and ground electrode GND1 can be adjusted so that antenna characteristics can be adjusted. Alternatively, by adjusting thickness D2 of protrusion 160, while strength of capacitive coupling between flat electrode 161 and ground electrode GND1 is maintained constant, a thickness D1 of dielectric layer 132 of antenna apparatus 120 can be increased, which can also contribute to a broader frequency bandwidth of radiated radio waves.

When ground electrode GND1 and ground electrode GND2 are capacitively coupled to each other, ground electrode GND1 and ground electrode GND2 do not strictly match in potential with each other. By matching the impedance as appropriate with the use of a capacitive element, an inductive element, or the like, however, ground electrode GND1 and ground electrode GND2 are electrically connected to each other in a specific frequency band so that power can be fed to the radiating element.

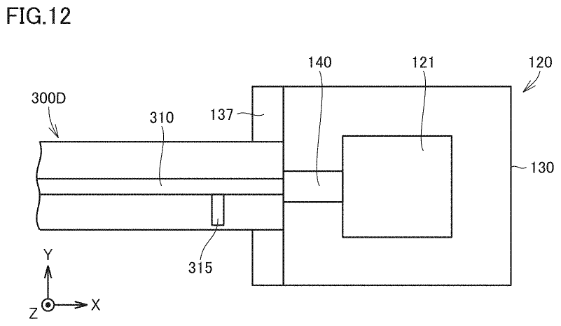

For example, in a fourth modification shown in FIG. 12, a short stub 315 having an end grounded is arranged in power feeder line 310 of a wiring cable 300D formed from a microstrip line, so as to achieve impedance matching between wiring cable 300D and antenna apparatus 120. In the fourth modification, though ground electrode GND1 and ground electrode GND2 are not physically connected to each other, a high-frequency signal can be transmitted through power feeder line 310 as a result of impedance matching achieved by stub 315 as described above.

In an example where wiring cable 300C as in the second embodiment is employed as well, the antenna apparatus and the wiring cable are arranged as described in the first embodiment. Therefore, the frequency bandwidth can be broader and increase in dimension of the device in the direction of thickness can be suppressed. Furthermore, by capacitively coupling the ground electrodes of the wiring cable and the antenna apparatus to each other, antenna characteristics can be adjusted.

The feature “electrical connection” in the present disclosure includes both of direct connection as in the first embodiment and capacitive coupling as in the second embodiment.

### Third Embodiment

A construction in which the ground electrode of the wiring cable and the ground electrode of the antenna apparatus are capacitively coupled to each other is described in the second embodiment. In a third embodiment, a construction in which a high-frequency signal is transmitted as a result of capacitive coupling also of the power feeder line of the wiring cable to the radiating element will be described.

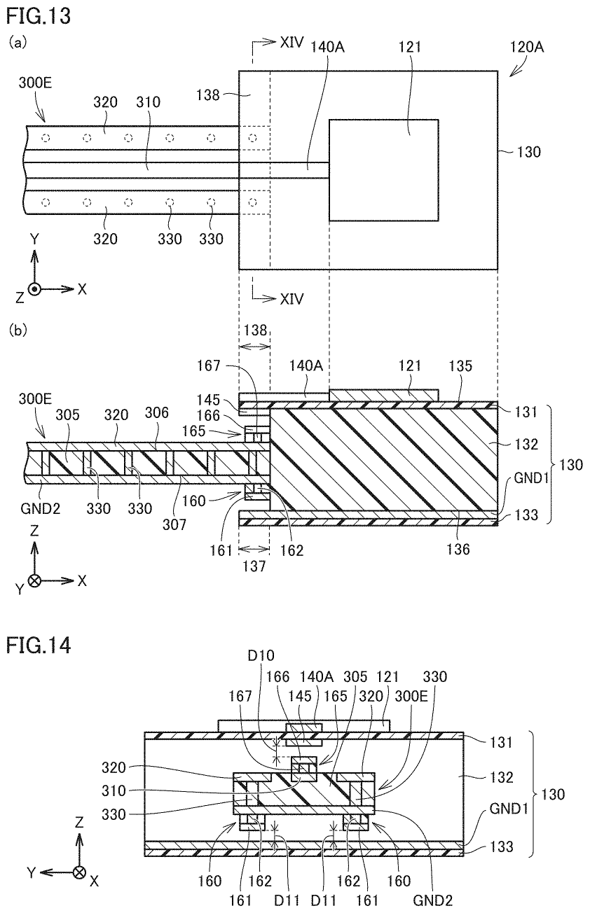

FIGS. 13 and 14 are diagrams for illustrating details of a connection structure in the third embodiment, that connects an antenna apparatus 120A and a wiring cable 300E to each other. FIG. 13 is a plan view (FIG. 13 (a)) and a side perspective view (FIG. 13 (b)) of a portion of connection between antenna apparatus 120A and wiring cable 300E. FIG. 14 is a cross-sectional view along the line XIV-XIV in FIG. 13.

In FIGS. 13 and 14, antenna apparatus 120 in the second embodiment is replaced with antenna apparatus 120A and wiring cable 300C is replaced with wiring cable 300E. Description of elements in FIGS. 13 and 14 similar to those in FIGS. 10 and 11 will not be repeated.

Referring to FIGS. 13 and 14, antenna apparatus 120A is provided with a projecting portion 138 (second projecting portion) also on the side of upper surface 135 of dielectric layer 132, in addition to projecting portion 137 on the side of lower surface 136. Specifically, dielectric film 131 projects from the end of dielectric layer 132 where projecting portion 137 is formed, and a wiring portion 140A connected to radiating element 121 also extends as far as the end of projecting dielectric film 131. On the lower surface side of dielectric film 131 in projecting portion 137, a flat electrode 145 is arranged as being opposed to wiring portion 140A. Wiring portion 140A and flat electrode 145 may directly be connected to each other through a via or the like.

Wiring cable 300E is constructed such that, on an upper surface side of wiring cable 300C described in the second embodiment, a protrusion 165 that protrudes from the upper surface is further added. Protrusion 165 includes a flat electrode 166 and a columnar electrode 167 similarly to protrusion 160. Flat electrode 166 is arranged as being opposed to power feeder line 310 and flat electrode 145 between power feeder line 310 formed on upper surface 306 of dielectric layer 305 and flat electrode 145 in projecting portion 138. Columnar electrode 167 is connected to flat electrode 166 and power feeder line 310. A dielectric may be arranged between flat electrode 166 and power feeder line 310. Though a space may be provided between flat electrode 145 and flat electrode 166, the space may be filled with a resin relatively low in dielectric constant. In order to lessen variation in capacitive coupling due to position displacement, preferably, a dimension of flat electrode 145 (or wiring portion 140A) in the Y-axis direction and a dimension of flat electrode 166 in the Y-axis direction are set such that any one is longer than the other.

According to such a construction, flat electrode 166 formed in protrusion 165 is capacitively coupled to wiring portion 140A through flat electrode 145 in projecting portion 138. Flat electrode 145 in projecting portion 138 is not essential, and flat electrode 166 of protrusion 165 may directly capacitively be coupled to wiring portion 140A. A protrusion may be formed on the side of ground electrode GND1 of dielectric substrate 130 also in the construction in FIG. 13.

By changing the thickness of protrusion 165 and/or an area of flat electrode 145 or 166, strength of capacitive coupling between flat electrode 166 and wiring portion 140A can be adjusted. By adjusting strength of capacitive coupling, impedance matching between wiring cable 300E and radiating element 121 can be achieved. The thickness of dielectric layer 132 in antenna apparatus 120A can further be increased by making use of capacitive coupling, which can also contribute to a broader frequency bandwidth of radiated radio waves.

“Protrusion 160” and “protrusion 165” in the third embodiment correspond to the “first protrusion” and the “second protrusion” in the present disclosure, respectively. “Flat electrode 161” and “flat electrode 166” in the third embodiment correspond to the “first electrode” and the “second electrode” in the present disclosure, respectively. Though a construction in which the wiring cable and the radiating element are capacitively coupled to each other and the ground electrodes of the wiring cable and the antenna apparatus are capacitively coupled to each other is described with reference to FIGS. 13 and 14, connection between the ground electrodes may be direct connection.

In an example where wiring cable 300E as described in the third embodiment is employed as well, the antenna apparatus and the wiring cable are arranged as described in the first embodiment. Therefore, the frequency bandwidth can be broader and increase in dimension of the device in the direction of thickness can be suppressed. Furthermore, by capacitively coupling the ground electrodes of the wiring cable and the antenna apparatus to each other and capacitively coupling the power feeder line and the radiating element to each other, antenna characteristics can be adjusted.

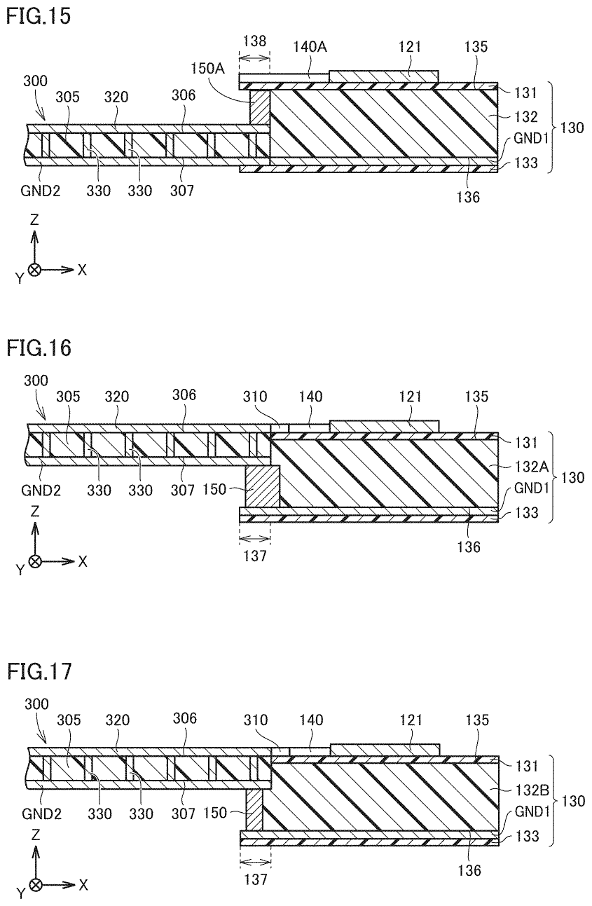

A construction in which ground electrode GND1 of the antenna apparatus and ground electrode GND2 of the wiring cable are arranged at positions different in the Z-axis direction is described in the embodiments and the modifications described above. As shown in a fifth modification in FIG. 15, however, wiring cable 300 may be arranged such that ground electrode GND1 and ground electrode GND2 are flush with each other and may be connected to radiating element 121 with solder 150A being interposed.

The side surface of the dielectric layer that faces the wiring cable in the dielectric substrate does not have to be a uniform plane. For example, as in a sixth modification shown in FIG. 16, a side surface of a dielectric layer 132A opposed to wiring cable 300 may protrude relative to a side surface thereof that faces solder 150. Alternatively, as in a seventh modification in FIG. 17, a side surface of a dielectric layer 132B that faces solder 150 may protrude relative to a side surface thereof opposed to wiring cable 300.

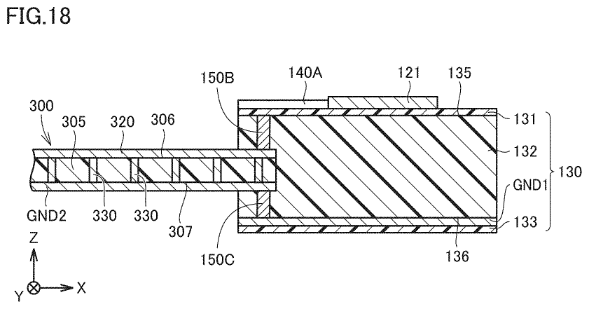

Furthermore, as shown in an eighth modification in FIG. 18, a projecting portion does not have to be provided in dielectric substrate 130. In the eighth modification, wiring cable 300 is arranged as being embedded in dielectric layer 132 of dielectric substrate 130. The side surface of dielectric layer 132 on the side of wiring cable 300 extends as far as the ends of dielectric films 131 and 133 and ground electrode GND1. Then, power feeder line 310 of wiring cable 300 is connected to wiring portion 140A through a via 150B, and ground electrode GND2 of wiring cable 300 is connected to ground electrode GND1 of dielectric substrate 130 through a via 150C. Connection between power feeder line 310 and wiring portion 140A may be direct connection through via 150B and connection between ground electrode GND2 and ground electrode GND1 may be direct connection through via 150C. Alternatively, the connection may be capacitive coupling as in antenna apparatus 120A in FIG. 13.

### Fourth Embodiment

An example in which the antenna apparatus is implemented by an array antenna including a plurality of radiating elements will be described in a fourth embodiment.

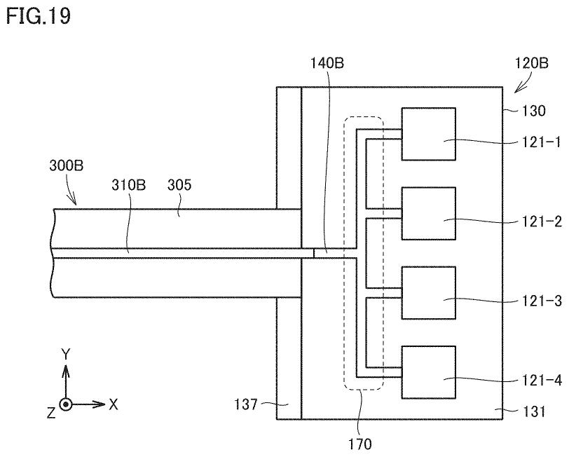

FIG. 19 is a plan view for illustrating a connection structure in the fourth embodiment, that connects an antenna apparatus 120B and wiring cable 300B to each other in the antenna module. Referring to FIG. 19, antenna apparatus 120B is an array antenna including four radiating elements 121-1 to 121-4 arranged in a line in the Y-axis direction.

Wiring cable 300B is a cable formed as a microstrip line as described in the third modification. Power feeder line 310B of wiring cable 300B has a part projecting from the end of dielectric layer 305 on the side of antenna apparatus 120 and connected to a wiring portion 140B at the upper surface of dielectric film 131 of antenna apparatus 120B.

Wiring portion 140B includes a divider 170 and branches a high-frequency signal received from power feeder line 310B of wiring cable 300B into four paths. The four branched paths are connected to four respective radiating elements 121-1 to 121-4.

Though not shown in FIG. 19, the ground electrode of wiring cable 300B is electrically connected to the ground electrode of antenna apparatus 120B by direct connection or capacitive coupling in projecting portion 137. The wiring cable may be formed as a coplanar line as described in the first embodiment or the second modification.

In connection between such an array-type antenna apparatus and the wiring cable as well, the antenna apparatus and the wiring cable are arranged as described in the first embodiment. Therefore, the frequency bandwidth can be broader and increase in dimension of the device in the direction of thickness can be suppressed.

(Ninth Modification)

An exemplary construction in which divider 170 formed in antenna apparatus 120B branches a high-frequency signal transmitted from RFIC 110 through wiring cable 300B and branched signals are supplied to radiating elements in the array antenna is described in the fourth embodiment. In a ninth modification, an example in which a high-frequency signal is transmitted to each radiating element in the array antenna through an individual power feeder line will be described.

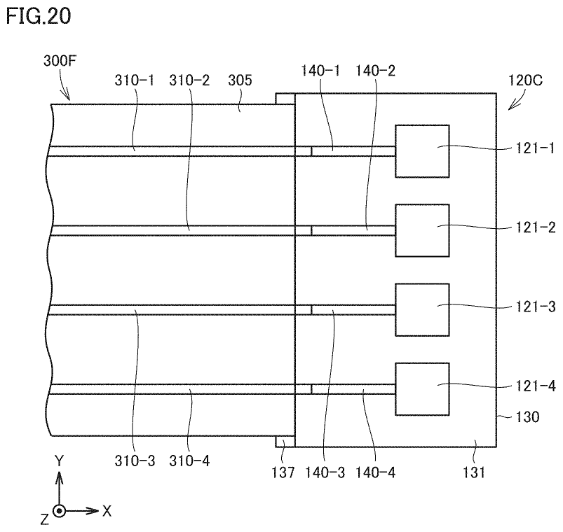

FIG. 20 is a plan view for illustrating a connection structure in the ninth modification, that connects an antenna apparatus 120C and a wiring cable 300F to each other in the antenna module. Referring to FIG. 20, antenna apparatus 120C is an array antenna including four radiating elements 121-1 to 121-4 arranged in a line in the Y-axis direction similarly to antenna apparatus 120B in the fourth embodiment.

Wiring cable 300F includes four power feeder lines 310-1 to 310-4 arranged in parallel to one another. Though not shown in FIG. 20, a ground electrode is arranged on the lower surface side of wiring cable 300F, and the ground electrode and each power feeder line form a microstrip line.

Four power feeder lines 310-1 to 310-4 each have a part projecting from the end of dielectric layer 305 on the side of antenna apparatus 120C and are connected to respective corresponding wiring portions 140-1 to 140-4 at the upper surface of dielectric film 131 of antenna apparatus 120C. Though not shown in FIG. 20, the ground electrode of wiring cable 300F is electrically connected to the ground electrode of antenna apparatus 120C in projecting portion 137 by direct connection or capacitive coupling.

In connection between the array-type antenna apparatus with such a connection structure and the wiring cable as well, the antenna apparatus and the wiring cable are arranged as described in the first embodiment. Therefore, the frequency bandwidth can be broader and increase in dimension of the device in the direction of thickness can be suppressed.

It should be understood that the embodiments disclosed herein are illustrative and non-restrictive in every respect. The scope of the present disclosure is defined by the terms of the claims rather than the description of the embodiments above and is intended to include any modifications within the scope and meaning equivalent to the terms of the claims.

### REFERENCE SIGNS LIST

10 communication apparatus; 100 antenna module; 110 RFIC; 111A to 111D, 113A to 113D, 117 switch; 112AR to 112DR low noise amplifier; 112AT to 112DT power amplifier; 114A to 114D attenuator; 115A to 115D phase shifter; 116 signal synthesizer/separator; 118 mixer; 119 amplifier circuit; 120, 120A to 120C antenna apparatus; 121, 121-1 to 121-4 radiating element; 130 dielectric substrate; 131, 133 dielectric film; 132, 132A, 132B, 305 dielectric layer; 137, 138 projecting portion; 140, 140-1 to 140-4, 140A, 140B, 340 wiring portion; 145, 161, 166 flat electrode; 150, 150A solder; 150B, 150C, 350 via; 155 anisotropic conductive film; 160, 165 protrusion; 162, 167 columnar electrode; 170 divider; 200 BBIC; 300, 300A to 300F wiring cable; 310, 310-1 to 310-4, 310A, 310B power feeder line; 315 stub; 320 ground wire; GND1, GND2, GND2A ground electrode

1. An antenna module comprising:
a dielectric layer in a form of a flat plate;
a first ground electrode arranged on a first surface of the dielectric layer;
a radiating element arranged on a second surface of the dielectric layer and opposed to the first ground electrode; and
a wiring cable that faces a side surface of the dielectric layer, the wiring cable including a second ground electrode and a power feeder line that conveys a radio frequency signal to the radiating element, wherein
the wiring cable is smaller in thickness than the dielectric layer,
the power feeder line and the second ground electrode are electrically connected to the radiating element and the first ground electrode, respectively, and
the second ground electrode is arranged at a position different from a position of the first ground electrode in a direction of thickness of the dielectric layer.

2. The antenna module according to claim 1, further comprising a connection member connected to the first ground electrode and the second ground electrode.

3. The antenna module according to claim 2, wherein
the first ground electrode includes a first projection that projects from an end surface of the dielectric layer,
a part of the second ground electrode is opposed to the first projection, and
the connection member comprises an anisotropic conductive film arranged as being in contact with the first ground electrode and the second ground electrode.

4. The antenna module according to claim 2, wherein
the connection member is solder.

5. The antenna module according to claim 1, wherein
the first ground electrode includes a first projection that projects from an end surface of the dielectric layer,
a part of the second ground electrode is opposed to the first projection, and
the first ground electrode and the second ground electrode are capacitively coupled to each other.

6. The antenna module according to claim 5, wherein
the wiring cable includes a first surface and a second surface,
a first protrusion is formed in a portion of the first surface opposed to the first projection, the first protrusion protrudes from the first surface of the wiring cable,
the first protrusion includes a first electrode arranged as being opposed to the first projection and connected to the second ground electrode, and
the first electrode and the first ground electrode are capacitively coupled to each other.

7. The antenna module according to claim 1, further comprising a wiring portion arranged on a second surface of the dielectric layer and connected to the radiating element, wherein
the wiring portion includes a second projection that projects from an end surface of the dielectric layer,
a part of the power feeder line is opposed to the second projection, and
the power feeder line and the wiring portion are capacitively coupled to each other.

8. The antenna module according to claim 7, wherein
the wiring cable includes a first surface and a second surface,
a second protrusion is formed in a portion of the second surface opposed to the second projection, the second protrusion protrudes from the second surface of the wiring cable,
the second protrusion includes a second electrode that opposes the second projecting portion and is connected to the power feeder line, and
the second electrode and the wiring portion are capacitively coupled to each other.

9. The antenna module according to claim 1, further comprising a wiring portion arranged on a second surface of the dielectric layer and connected to the radiating element, wherein
the power feeder line projects from an end surface of the wiring cable that faces the dielectric layer in a direction toward the radiating element, and
the power feeder line and the wiring portion are electrically connected to each other.

10. The antenna module according to claim 1, wherein
the wiring cable is flexible.

11. The antenna module according to claim 1, wherein
the power feeder line and the second ground electrode form a strip line, a microstrip line, or a coplanar line.

12. A connection structure that connects an antenna apparatus and a wiring cable to each other, wherein
the antenna apparatus includes
a dielectric layer in a form of a flat plate,
a first ground electrode arranged on a first surface of the dielectric layer, and
a radiating element arranged on a second surface of the dielectric layer and opposed to the first ground electrode,
the wiring cable that faces a side surface of the dielectric layer,
the wiring cable includes
a second ground electrode, and
a power feeder line that conveys a radio frequency signal to the radiating element,
the wiring cable is smaller in thickness than the dielectric layer,
the power feeder line and the second ground electrode are electrically connected to the radiating element and the first ground electrode, respectively, and
the second ground electrode is arranged at a position different from a position of the first ground electrode in a direction of thickness of the dielectric layer.

13. The connection structure according to claim 12, further comprising a connection member connected to the first ground electrode and the second ground electrode.

14. The connection structure according to claim 13, wherein
the first ground electrode includes a first projection that projects from an end surface of the dielectric layer,
a part of the second ground electrode is opposed to the first projection, and
the connection member comprises an anisotropic conductive film arranged as being in contact with the first ground electrode and the second ground electrode.

15. The connection structure according to claim 13, wherein
the connection member is solder.

16. The connection structure according to claim 12, wherein
the first ground electrode includes a first projection that projects from an end surface of the dielectric layer,
a part of the second ground electrode is opposed to the first projection, and
the first ground electrode and the second ground electrode are capacitively coupled to each other.

17. The connection structure according to claim 16, wherein
the wiring cable includes a first surface and a second surface,
a first protrusion is formed in a portion of the first surface opposed to the first projection, the first protrusion protrudes from the first surface of the wiring cable,
the first protrusion includes a first electrode arranged as being opposed to the first projection and connected to the second ground electrode, and
the first electrode and the first ground electrode are capacitively coupled to each other.

18. The connection structure according to claim 12, further comprising a wiring portion arranged on a second surface of the dielectric layer and connected to the radiating element, wherein
the wiring portion includes a second projection that projects from an end surface of the dielectric layer,
a part of the power feeder line is opposed to the second projection, and
the power feeder line and the wiring portion are capacitively coupled to each other.

19. The connection structure according to claim 18, wherein
the wiring cable includes a first surface and a second surface,
a second protrusion is formed in a portion of the second surface opposed to the second projection, the second protrusion protrudes from the second surface of the wiring cable,
the second protrusion includes a second electrode that opposes the second projecting portion and is connected to the power feeder line, and
the second electrode and the wiring portion are capacitively coupled to each other.

20. The connection structure according to claim 12, further comprising a wiring portion arranged on a second surface of the dielectric layer and connected to the radiating element, wherein
the power feeder line projects from an end surface of the wiring cable that faces the dielectric layer in a direction toward the radiating element, and
the power feeder line and the wiring portion are electrically connected to each other.
